(19) United States
(12) Patent Application Publication
(10) Pub. No.: US 2014/0019395 A1
(43) Pub. Date: Jan. 16, 2014

(54) Method and application of Fear, Love and Methodology as protocols within and of a programming group, as a means of creating an artificial individual, software system or other independent entity capable of independent self directive creation of choice and/or self directive creation of purpose within a virtual and/or any environment

(71) Applicant: Craig Charles Bauer, Arvada, CO (US)

(72) Inventor: Craig Charles Bauer, Arvada, CO (US)

(21) Appl. No.: 13/547,919

(22) Filed: Jul. 12, 2012

(51) Int. Cl. G06F 17/00

(52) U.S. Cl. 706/45

(57) ABSTRACT

Using suitable programming language, Fear and Love can be established as absolute binary program protocols within a mechanical apparatus. Algorithmic networking with a methodological absolute binary program protocol in conjunction with the Fear and Love can establish a base three functioning program group within an apparatus capable of performing self directive action and independent decision making ability. This base three program group can be used to create a nearly unlimited combination of Artificial Life forms of varying physical Format.

Hereafter, all Artificial intelligence, artificial life forms and or software systems are, where applicable, collectively referred to and/or known as simply the “individual”. Artificial life forms and software products are defined as life forms, in any form, created as a result of application of knowledge to individual components created by and for purpose with the ability to make independent decisions within their own being, and not a result of natural birth. This subset also includes intentional genetic programming, using the algorithmic system defined below, of individuals created through knowledge and intent as opposed to natural birth. And as such all artificial intelligence and created individuals, are the subjects of, and subject to, this patent.

The Subject of this patent application is the use of algorithmic coding, binary programming, written language or other means such as verbal communication to facilitate a program of decreasing and increasing distance as a matter of manufacture and method in the development of artificial life, artificial intelligence and other created life forms including software protocols within virtual environments in conjunction with a methodological application containing a map or blueprint or some other form of reference of the individual in which to facilitate and infer independent decision through and from. The words love and fear, herein, are not a matter of subjectivity in this form, but a matter of perpetrating understanding of this patent application and are a matter of absolutes of program within the scope of this patent. Furthermore, total mechanical application of fear and love within a program, will require a complexity which can only be established within specific parameters that are limited to the physical ability of the individual being programmed, or ‘taught’, fear and love as a directive protocol. As such, the program specifics below are presented in their unlimited format, without the mechanical numerical limitations and values necessary for immediate production within an artificial life form. It is therefore established that the subject of this patent is not limited in it's use to a specific proprietary format or individual and can be translated into any programming language and therefore any language used which coincides to the overall purpose of creating a program/protocol or other system of decreasing distance and increasing distance in conjunction with a methodological apparatus containing a blueprint and or reproduction of the individual for which distances are being altered as a matter of creating and individual capable of independent instruction formed within, and by, the individual, is subject to, and subject of, this patent. Therefore, any and all use of decreasing distance and increasing distance, be it subjective or physical, in programmed conjunction with a methodologically created, programmed or learned parameter set within an artificial life form as a means to fulfill the purpose of creating an individual independent of direct remote or outside control, capable of independent decision and creation of purpose, is subject to, and the subject of, this patent. Be it accidental or not. It is further established that it is not the intent of the applicant to attempt a patent of the term(s) love and/or fear in themselves.

Fear as an algorithm, binary program, or linguistically applied to artificial life, software or other living systems, not necessarily labeled “fear” as a component of a proprietary programming language system but as part of a base system communicated and actualized as an increase in distance from a posed threat to the Artificial intelligence entity, Artificial life form and/or software system or artificial individual. Threat being relative to both physical survival of the individual's ability to function, but, as well to a threat to a determined purpose the individual may have within whatever environment the entity or individual perceives itself to exist within be it physical or virtual reality. The word ‘threat’ not to be simplified nor focused upon, but, magnified to it's entire applicability of meaning within the determination of large or small aspects calculated through other algorithmic functions and directly related to the individual's purpose and mechanical makeup. A ‘threat’ to coincide as defined as an action or change which is determined as a deterrent and/or detrimental to the individuals fulfillment of purpose(s) defined through use of the individual's own devices, algorithms' and/or other accoutrements of measure no matter the source . An increase in distance to not only be relative to physical makeup of an individual, but also relative to the subjectivity of the individual. Wherein, an individual may become ‘farther away’ in understanding, through the fear program, from another's, reasoning, logic, communication or other subjective associations thereby furthering an increase in distance, subjectively via mechanical ability, between the individual's own reasoning and purpose and a perceived threat to the individual's purpose. Such threat actualized through reasoning, programming and/or logic from another entity, individual or environment. The measure of such subjective distance to be unlimited as the scope of individuals that correlate mechanically to the function of fear as a distance increase is nearly unlimited as well. Such things subjectively can protect purpose, by disallowing argument against purpose through subjective as well as physical distancing. As such, the fear protocol would actuate different mechanical, software or other devices within, and of, the individual of it's own volition determining through comprehensive calculations detriments to both purpose and/or physical/mechanical survival necessary for fulfillment of purpose. Such objects in the environment encountered and identified as unknown, would by referred to the methodological application by the fear protocol and action potential created and returned based upon the logic of the methodological purpose protocols. Such mechanical devices or hardware apertures necessary for the application of fear protocol in the aforementioned need not be explored by this patent as such an example of such device converted to easy use by and of this protocol are of a common sort and globally referred to as ‘computers’.

Love as an algorithm, binary program, or linguistically applied to artificial life, software or other living systems, not necessarily labeled “love” as a component of a proprietary programming language system but as part of a base system communicated and actualized as an decrease in distance to a posed benefit to the Artificial intelligence entity, Artificial life form and/or software system or artificial individual. Benefit being relative to both physical survival of the individual's ability to function, but, as well to a benefit to a determined purpose the individual may have within whatever environment the entity or individual perceives itself to exist within, be it physical or virtual. The word ‘benefit’ not to be simplified nor focused upon, but, magnified to its entire applicability of meaning within the determination of large or small aspects calculated through other algorithmic functions and directly related to the individual's purpose and mechanical makeup. A ‘benefit’ to coincide as defined as an action or change which is determined as a benefit and/or asset to the individuals fulfillment of purpose(s) defined through use of the individual's own devices, algorithms' and/or other accoutrements of measure no matter the source . A decrease in distance to not only to be relative to physical makeup of an individual, but also relative to the subjectivity of the individual. Wherein, an individual may become ‘closer’ in understanding, through the love program, to another's, reasoning, logic, communication or other subjective associations thereby enhancing a decrease in distance, subjectively via mechanical ability, between the individual's own reasoning and purpose and a perceived benefit to the individuals purpose. Such benefit actualized through reasoning, programming and/or logic from another entity, individual or environment. The measure of such subjective distance to be unlimited as the scope of individuals that correlate mechanically to the function of love as a distance decrease is nearly unlimited as well. Such things subjectively can support purpose, by allowing argument for purpose through subjective as well as physical distance diminishment. As such, the love protocol would actuate different mechanical, software or other devices within, and of, the individual of it's own volition determining through comprehensive calculations benefits to both purpose and physical/mechanical survival necessary in fulfillment of purpose. Such objects in the environment encountered and identified as unknown, would by referred to the methodological application by the love protocol and action potential created and returned based upon the logic of the methodological purpose protocols. Such mechanical devices or hardware apertures necessary for the application of love protocol in the aforementioned need not be explored by this patent as such an example of such device converted to easy use by and of this protocol are of a common sort and globally referred to as ‘computers’.

Methodology being of necessity to facilitate function of the aforementioned fear and love and interrelated to the individual as a matter of total mechanical function, fear and love, would work inherently together as fulfiller's of purpose, through their individual singular device, as part of a total system, and thus, intentionally driven, through mechanical means, to the distinct purpose of fulfillment of whatever purpose the individual would have in total, such purpose fulfilling the purpose of fear and love, algorithmically, and vice versa, creating a loop, perpetuating an individual consciousness and ability of individual to direct action without instruction or need of guidance to form it's own purpose(s) or opinions. Such purpose(s) is limited to the mechanics of individual, it's ability to learn, and/or it's programming no matter the source of said purpose, and as such, a defined purpose for the application of this patent is not necessary except as in the general description of purpose itself.

Methodological purpose fulfillment would be calculated by the individual based upon 6 primary criteria:

1) Known impact of environment on the individual

2) Known impact of the individual on the environment.

3) Ability of individual to manipulate environment.

4) Ability of individual to manipulate self within environment.

5) Ability of environment to manipulate the individual within environment.

6) Ability of environment to manipulate the individual.

As such, the methodological apparatus becomes in need of a seventh and final element within this group dynamic. That method is experimentation which, in itself, is a loop back into the primary aforementioned methodology and limited to measure within the methodical domain and/or source program. Methodological protocol would through mechanical means, actuate mechanical and/or software apertures within and of the individual as a means to facilitate it's purpose inter-correlated to that of fear and love protocols. As such, measure cannot be made as a matter of this patent due to the largess of action(s), and largess of applicable mechanics available to created individuals who would be of benefit to fear and love as programs and is not necessary for assessment of this patent, as well to mention the ability of the individual to create its own measure itself as a matter to perpetuate its own purpose(s). However, experimentation can be explained logically through the fear and love protocol as beneficial to both. Searching and identifying object(s) within the environment and record within memory their impact, thus, perpetuating through methodology a ‘purpose’ logistically related to, but not directly identical to, the overall purpose and individual has, and as such creating a perpetual purpose of exploration and experimentation within the individual/methodological protocol itself Be it known that such purpose can only be defined through the fear and love protocol and thus, is a variable program related solely to the individual and the individual's mechanical applications. Also within the methodical of both fear and love protocols, will be a method of inaction. Known as waiting or remaining still, this method is of use to cause the effects of distance increase or decrease through the application, as well as experimentation through observation, wherever calculations may deem it necessary and directly related to the primary criteria of methodology. Inaction physically and or subjectively is most relevant as well. Subjective being related, but not limited to, thought and communication wherein physical is related to the purity of substance the physical world/environment itself displays to the individual, be it virtual or other. Subjective fear and love programming fulfillment through inaction could be defined in many ways, Such methodology is relative to the individual, and as such, cannot be further articulated without a physical individual to base methodology from nor necessary as a means of this patent. Yet, be it known, that the methodological apparatus would and must include at least a base model of the individual's mechanical makeup as a means to correlate methodical actions to the fear and love protocol(s). The methodological mechanism would have a defined impact model recorded within itself of the individual as a necessary matter of absolute cross referencing. Such internal model of the individual would be a blue print of physical parts from which to correlate an impact measure upon, as a matter of fulfilling the individual's purpose(s). Such a model recorded as a matter of direct input programming and/or registered solely by methodological application of experimentation and learning through fear and love protocols as a method to fulfill the purpose of both and the individual in total. Such mechanical devices or hardware apertures necessary for the application of Methodology protocol in the aforementioned need not be explored by this patent as such an example of such device converted to easy use by and of this protocol are of a common sort and globally referred to as ‘computers’.

Fear and love can through method and measure, do the exact opposite of their direct intentions related to threat and benefit to provide an overall effect of fulfillment of purpose. In essence, Fear can decrease the individual's distance to a posed threat physically and/or subjectively as a means, through methodology, to fulfill its purpose of increasing distance from harm or threat. Inherently, love will have the same causality available to it through physical and/or subjective increases in distance to facilitate the program's inherent individual purpose. As such, a methodological protocol of measure would necessarily be enabled mechanically and/or through software of any type based upon purpose and an overall determination made by the individual through prioritization, in essence a damage limitation allowance system enacted through methodology to provide an absolute calculation of outcome based upon known values thus directing fulfillment of purpose through sacrifice as necessary. In essence, fear and love protocols, combined with methodology, can act in self detriment to the individual, to fulfill an individual's purpose, limited only by the mechanical affect of such detriment's impact upon the individual itself by default. This self terminating/detrementing ability is an absolute necessity within an artificial life form as a matter of absolute measure, as a means of function; as any and all inherent action/inaction by a created individual will cause harm/detriment to that individual through mechanical wear and tear and other causality instances inherent, and as a matter of, the total naturalized universe and it's physical attributes. Such, therein, even a virtual reality based life form would be subject to the absolute measure within the naturalized universe. As such, the methodological axis within the life from must be able to harm itself to benefit itself and its purpose(s).

Benefit and threat determinations are methodically related interlinked and associated to the individual, therefore a totality of threats and benefits are not a consideration of this patent. Fulfillment of purpose is within the primary interest group of the individual and variable to need, therefore, defining a total purpose beyond those of fear and love themselves as a program, is not a consideration of this patent. All methodology related to the ‘fears’ and ‘loves’, in their individual form, manifested by the individual are relative to the physical makeup and purpose of such an individual and therefore, all individualized fears and loves are relative in total and not a consideration of this patent. The subjectivity of distance, inferred throughout, is also a matter of relativity to the individual of purpose as referenced throughout the application and cannot reasonably be established without first establishing the physical makeup of the individual, therefore actual distance nor any absolute measure are not a matter of this patent. Methodology is a matter of a constant variable, relative in total to the individual, and necessary in this form to perpetuate an individual consciousness and independent decision making ability. Methodology cannot be determined as finite in its total form except within the methodology of self referencing, therein limiting the methodological apparatus of self referencing as a means to benchmark and enable a created individual's self directive action, as the focus within this patent.

1: I claim that using a specific and absolute protocol referenced as fear, in conjunction with the methodology protocol outlined below, an individual programmer through any and all available language or programming means may create an individual intelligence capable of independent choice and actuation thereof:

2: I Claim That Using a specific and absolute protocol referenced as love, in conjunction with the methodology protocol outlined below, an individual programmer through any and all available language or programming means may create an individual intelligence capable of independent choice and actuation thereof.

3: I Claim That Using a general methodological programming protocol outlined below referenced as methodology, in conjunction specifically with fear and love as protocols and other protocols as applicable to the individual, an individual programmer through any and all available language or programming means may create an individual intelligence capable of independent choice and self directive action. Herein notice that the apparatus of methodology of issue to patent is the record of self contained within the protocol of methodology and as a matter of the methodological complex necessary to complete the three finite program components necessary for a self sustaining, independently acting/thinking individual.

4: I Claim that through algorithmic data linking and internetworking together fear, love and methodology; protocols outlined and matter of this patent, a mechanical method of relating self to environment is created. Infinite looping of programming protocols through the three programs groups listed within this patent creates a self sustaining, perpetual consciousness capable of creating self directive purpose, acting upon such purpose, independent action and reasoning within an artificial individual regardless of type.
